(19) United States
(12) Patent Application Publication
(10) Pub. No.: US 2026/0301708 A1
(43) Pub. Date: Oct. 1, 2026

(54) UNIFORM DISPLAY OF VISUAL MEDIA

(71) Applicant: Adeia Guides Inc., San Jose, CA (US)

(72) Inventor: Tao Chen, Palo Alto, CA (US)

(21) Appl. No.: 19/096,203

(22) Filed: Mar. 31, 2025

(51) Int. Cl. G09G 5/00; G09G 5/10; H04N 17/02; H04N 17/04

(52) U.S. Cl. CPC G09G 5/003; G09G 5/10; H04N 17/02; H04N 17/04; G09G 2320/0626; G09G 2320/066; G09G 2320/0666; G09G 2320/0693

(57) ABSTRACT

Methods and systems are provided for consistent visual content across different displays by compensating for variations in image processing. Instead of optimizing for the best picture on each display, methods and systems are configured to ensure uniformity across different displays. Optimization is achieved by estimating the processing each display applies to an image and then applying an inverse process to the input image to counteract these changes. Adjustments in brightness, contrast, saturation, sharpness, and noise reduction may be estimated and compensated. The methods and systems may include analyzing a first input image and capturing the output image from the display device, then applying an inverse of the estimated processing operations to a second input image to generate a compensated third input image. Iterative refinement and neural networks may be used for accurate compensation. As a result, consistent visual content presentation across various display devices, regardless of hardware differences and settings, is achieved.

### TECHNICAL FIELD

The present disclosure relates to content delivery, including methods and systems for ensuring consistent visual content presentation across various consumer and professional display devices by compensating for differences in hardware, settings, and image processing techniques.

### SUMMARY

Traditional methods for displaying visual content on consumer devices focus on optimizing the content to make the most of capabilities of a given display. In one approach, settings on a given display such as brightness, contrast, and color are adjusted in an effort to optimize the displayed picture on that given display. However, this approach can lead to inconsistencies between displays, as the same image can look different on various displays due to differences in hardware, settings, age, applied image processing techniques, manufacturing variabilities, and other factors (e.g., even when the same or similar settings are applied to two different displays of the same make, model, and age).

In some instances, a given display may be calibrated in an effort to produce “true” colors (e.g., for photo editing). This may be done by calibrating to a professional reference monitor. However, calibrating consumer displays to match professional reference monitors is challenging and impractical. Variations in manufacturing and components mean that even displays of the same model can show significant differences. Professional calibration tools and environments may be utilized, but such tools and environments are not accessible to most consumers. Additionally, consumer displays cannot be easily calibrated to behave like reference monitors due to lesser performing design and hardware specs. All displays of consumer and professional grades, due to drift issues over time, require periodic recalibration, which is impractical for consumers in everyday use. Even if one were to calibrate two displays to a professional reference monitor, inconsistencies still arise between them due to inherent variations in manufacturing and components.

In an approach, a path planning algorithm was proposed for image enhancement. The approach emulates image enhancement processes by generating a sequence of enhancing operators that approximate image enhancement models. The method addresses a lack of interpretability in existing image-to-image translation methods, which may produce acceptable results but suffer from artifact generation and poor scalability to high resolutions. In another approach, a multi-stage deep learning approach was proposed for removing reflections from burst images using reflection motion aggregation (RMA). The method includes pre-processing to suppress reflections in individual images, extracting the RMA cue to emphasize a transmission layer, and guiding final reflection removal. However, these and other approaches do not provide consistent visual content presentation between displays.

These and other problems are overcome by one or more of the disclosed methods and systems, which may be applied to provide consistent visual content presentation between displays. These methods and systems reduce inconsistencies between displays and ensure that visual content looks the same (e.g., consistent or uniform) across different displays. In some embodiments, instead of optimizing for the best possible picture on each display, the focus instead is on achieving consistency between displays. Consistence across different displays is achieved, for example, by estimating the processing that each display applies to the image (including, e.g., enhancements) and then applying an inverse process (representing an inverse of the estimated processing) to the input image to compensate for these changes. Adjustments estimated to have been made during image processing such as brightness, contrast, and saturation may be estimated and compensated. Other post-processing enhancements, such as sharpness and noise reduction, may also be considered and compensated for.

In some embodiments, a method comprises estimating a set of image processing operations for a display device. This estimation may be based on an analysis of a first input image and a capture of an output image presented by the display device using the first input image as input. The estimated set of image processing operations may represent an estimation of one or more operations applicable to the first input image to generate the capture. For example, one might say the estimated set of image processing operations is a set of operations that, hypothetically, if applied to the first input image, would result in the capture. That is, for example, the aforementioned “capture” relates to estimation of processes on the display device. The estimated processes are applicable to the first input image to generate the displayed image and/or the output image presented by the display device. In the aforementioned capture, for example, camera image signal processor (ISP), which may be included in the capturing device, is not part of the aforementioned estimated processes. Use of a RAW mode for image acquisition improves the process because the RAW mode excludes the camera ISP. In a non-RAW mode, the camera ISP is expected to be reverted, i.e., e.g., going back to RAW mode, approximately.

Also, for example, in some instances, a camera captures an image in a RAW mode. In some instances, the camera does not capture the image in a RAW mode. The system may convert the RAW mode data to a non-RAW mode image.

In some instances, the accuracy or precision of the estimate of the set of operations is tested, the estimate being the set of operations that, hypothetically, if applied to the first input image, would result in the capture. For example, one might apply the estimated set of operations to the first input image to generate a test image, if displayed at a reference monitor, it would look like what is displayed on the display that presented the image represented in the capture. Then, one might display the test image at the reference monitor and compare it to the output image at the display and determine a difference between the two. Ideally it is zero, which indicates the estimate is good. If the difference is, for example, above a threshold, then one may attempt a modification of the estimated set of operations to the first input image to generate a test image.

For example, the method comprises applying an inverse of the estimated set of image processing operations to a second input image to generate a third input image. The third input image represents a version of the second input image for which the estimated set of image processing operations have been compensated. The method comprises causing the display device to display a second output image using the third input image.

In some embodiments, the inverse of the estimated set of image processing operations to generate the third input image comprises estimating processing parameters. For example, the estimation of the set of image processing operations may comprise estimating the application of the image processing by the display device to the second input image, i.e., e.g., adjusting brightness, contrast, color, saturation, sharpness, or noise reduction.

In other embodiments, the inverse of the estimated set of image processing operations to generate the third input image comprises reversing the effects of the estimated application of the processing operations. The process may also comprise generating a compensated image.

For example, the inverse of the estimated set of image processing operations may comprise iterative refinement, i.e., e.g., repeatedly adjusting the estimation of the set of image processing operations and applying the inverse process until a desired consistency is achieved. In some cases, a neural network may be configured to estimate and compensate for the image processing operations applicable by the display device.

In some embodiments, the analysis of the first input image and the capture of the output image presented by the display device comprises capturing the output image using a camera or sensor. The method comprises comparing the capture of the output image with the first input image to identify differences attributable to the processing operations of the display device.

For example, the estimated set of image processing operations may comprise identifying one or more image processing applications utilized by the display device. The method comprises quantifying the impact of each identified image processing application on the first input image.

In some embodiments, a software module is configured to perform the inverse of the estimated set of image processing operations and apply the inverse to the second input image.

Another method comprises estimating a set of image processing operations for a display device based on an analysis of a first input image and a capture of a first output image presented by the display device using the first input image as input. The estimated set of image processing operations represents the change between the first input image and the capture of the first output image if applied to the first input image.

For example, the method comprises applying an inverse of the estimated set of image processing operations to a second input image to generate a third input image. The third input image represents a version of the second input image for which the estimated set of image processing operations have been compensated. The display device displays a second output image using the third input image.

In some embodiments, the third input image is an intermediate image. The method may comprise applying image enhancement, display settings, and ambient factors relative to the third input image after applying the inverse of the estimated set of image processing operations to the second input image.

For example, the estimated set of processing operations may comprise adjustments in color, brightness, contrast, and saturation. The method may also comprise iteratively adjusting the estimation of the set of image processing operations and generating the third input image.

In some cases, the estimated set of processing operations comprises capturing an image with an image capture device operating in a RAW image format mode.

In some embodiments, a method comprises estimating a variation in display processing parameters for a display device, compensating an input image based on the estimated variation, and generating the compensated image for output on the display device. For example, the display processing parameters may include panel quality, backlight, and polarizer variations, or adjustments in color, brightness, contrast, and saturation. Estimating the variation may comprise capturing an image of the display device with an image capture device, generating a test pattern with the image capture device, and transmitting the test pattern to the display device. Additionally, configuring camera settings of the image capture device may be part of the process.

In some embodiments, the estimation and generation of the compensated image may be performed on the image capture device or on a remote computing resource. The compensation of the input image may be dynamic, based on real-time estimation of the display processing parameters. The display device may be a multi-screen device, with each screen displaying a portion of the compensated image. Estimating the variation for each screen may comprise an inverse process, and pre-processing may be performed before generating the compensated image.

A common module may control pre-processing, splitting a large image or video frame to fit each screen, and transmitting each portion to the respective screen. Another method for ensuring consistent visual content presentation across multiple displays comprises receiving an input image, estimating the processing effect of a target display, generating an inverse transformation, applying it to the input image to create a compensated image, and transmitting the compensated image to the target display. As a result, the compensated image appears consistent with the input image on a reference display. For example, a smartphone may send images or test patterns to the target display, capture the displayed images or test patterns, and perform the capture in RAW mode.

Related devices, systems, non-transitory computer-readable media, and the like are provided for ensuring consistent visual content presentation across various consumer and professional display devices by compensating for differences in hardware, settings, and image processing techniques.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals may indicate identical or functionally similar elements, and in which:

FIG. 1 depicts a system including a smartphone for collecting images of samples and applying analysis for color changes, in accordance with some embodiments of the disclosure;

FIG. 2 is a flowchart of a method for determining a difference between an image perceived on different displays;

FIG. 3 is a flowchart of a method for estimating and compensating of image processing, in accordance with some embodiments of the disclosure;

FIG. 4 is a flowchart of a method for estimating image processing through a capturing device in RAW mode, in accordance with some embodiments of the disclosure;

FIG. 5 is a flowchart of another method for estimating image processing through a capturing device, in accordance with some embodiments of the disclosure;

FIG. 6 is a flowchart of a method for estimating or training for the forward and inverse of image processing, in accordance with some embodiments of the disclosure;

FIG. 7 is a flowchart of a method for processing applied to achieve consistency with a reference, in accordance with some embodiments of the disclosure;

FIG. 8 is a flowchart of a method for refining an inverse process, in accordance with some embodiments of the disclosure;

FIG. 9 is a flowchart of a method for applying processes, with a replacement of the refined inverse process, to achieve consistency with a reference, in accordance with some embodiments of the disclosure;

FIG. 10 is a flowchart of a method for estimating image processing operations based on an analysis of input and output images, applying the inverse of these operations to a second input image derived from the first, and displaying the compensated image on the device, in accordance with some embodiments of the disclosure;

FIG. 11 is a flowchart of a method for estimating image processing operations based on an analysis of input and output images, applying the inverse of these operations to a second input image to generate a compensated version, and displaying the resulting image on the device, in accordance with some embodiments of the disclosure;

FIG. 12 is a flowchart of a method for estimating variations in display processing parameters, compensating an input image based on these variations, and generating the compensated image for display, in accordance with some embodiments of the disclosure;

FIG. 13 is a flowchart of a method for ensuring consistent visual content across multiple displays by estimating and inversely transforming the processing effects of a target display, then applying this transformation to an input image before transmitting it to the target display, in accordance with some embodiments of the disclosure;

FIG. 14 depicts an artificial intelligence (AI) system, in accordance with some embodiments of the disclosure; and

FIG. 15 depicts a system including a server, a communication network, and a computing device for performing the methods and processes, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

A smartphone is configured to take pictures of different displays. The smartphone is configured to check if, for example, the colors in the pictures change over time. When the pictures are viewed on different screens, like a TV or computer, the pictures might look different because each screen has its own way of showing pictures. To figure out how much the picture has changed, common adjustments like brightness, contrast, and color saturation are evaluated. For example, if the screen makes the picture 10% brighter or 15% more colorful, these changes are estimated and used to adjust the picture in the opposite way before it is shown on the screen. By doing so, the picture looks the same on different screens, even if they have different settings.

Also, when a picture is taken with a smartphone, camera settings like shutter speed, ISO, and aperture can be set to fixed values to make sure the pictures are consistent. Test images and patterns are used to compare the pictures and a reference monitor with specific settings for brightness and color. Sometimes, reflections and glare can affect the picture. Methods and systems are provided to remove these effects to obtain a consistent picture. Thus, the picture looks the same on different screens by estimating and adjusting for any changes. This process can be repeated to achieve the best results.

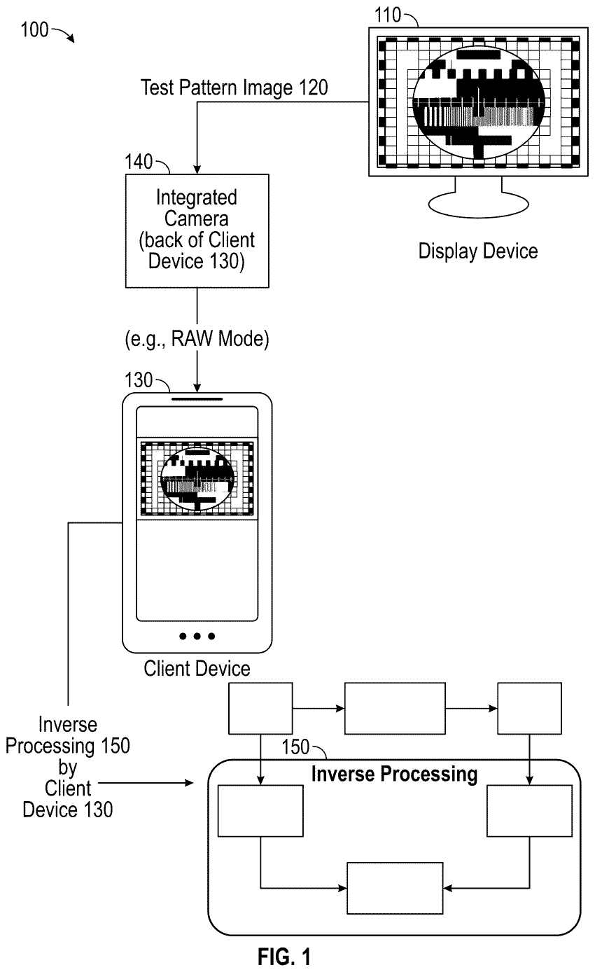

FIG. 1 depicts a system 100 including a client device 130 (e.g., a smartphone) for collecting images (e.g., a test pattern image 120 displayed by a display device 110; the test pattern image 120 may be captured in RAW mode) of samples (e.g., a test pattern) and applying analysis (e.g., inverse processing 140) for color changes, in accordance with some embodiments of the disclosure.

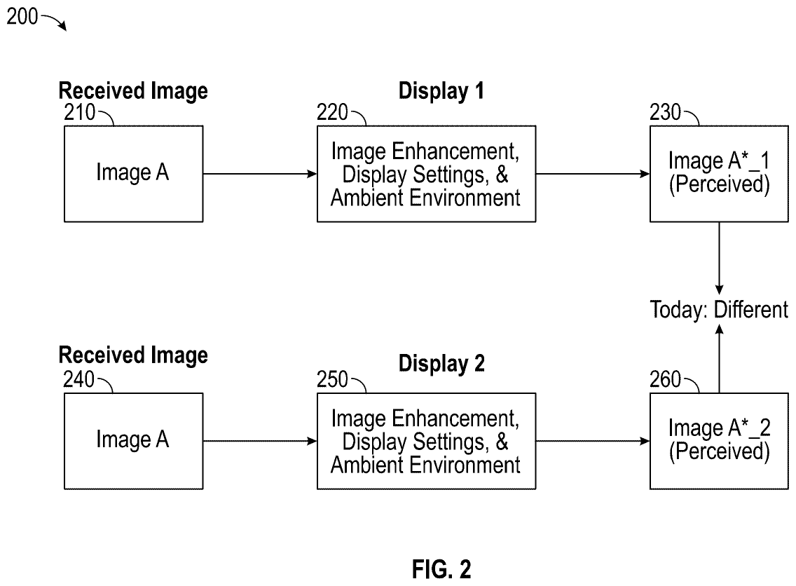

On consumer devices, visual content (image, video, or the like) presentation and perception are largely impacted by image and/or video enhancement, display capability, settings, and ambient environment, as illustrated in FIG. 2. Therefore, it is very common for a same picture to appear and be perceived differently from one display to another, either in a same or different environment. The variations include visible difference in colors, contrast, brightness, sharpness, or the like.

FIG. 2 is a flowchart 200 of a method for determining a difference between an image perceived on different displays. An initial image A is received (210) by a system and displayed on two different displays, e.g., at Display 1 (at 220) and Display 2 (at 250). On Display 1, the original image (Image A) undergoes enhancement and is perceived as Image A*_1 (230). Similarly, on Display 2, the original image (Image A) is enhanced and perceived as Image A*_2 (260). However, the perceived quality of the image is different and is influenced by factors such as image enhancement techniques, display settings, and the ambient environment.

Content adaptation (appliable to both SDR and HDR) on consumer devices usually optimizes the presentation towards the best capability and the current settings of the display. Since the combinations of display capabilities and settings typically vary, there are divergent presentation and perception of a same picture on different displays, even if the image enhancement is the same or is all turned off. In practice, it remains impossible to calibrate (or even by turning off all the enhancement, conforming the settings, or the like) consumer displays to behave like a reference (or, a nominal reference) monitor so that a same picture would look the same on all screens. In addition, most if not all monitors will exhibit drift issues over time, and thus it is usually recommended or mandated for periodic calibration (e.g., every six months) for professional mastering monitors. This is impractical for consumer devices.

In mass production of consumer TVs, the same configuration of settings will be populated to all the units of the model. The variations of panel quality, backlight, polarizer, or the like may exhibit a range of [−20%, 20%], even for the same design spec of a same model from a same original equipment manufacturer (OEM). Calibration requires professional software and hardware tools as well as a well-designed and controlled environment. Access to the factory menu and settings is extremely limited, which is inevitable in calibration and optimization for picture quality. Adjustment through common TV menus usually does not allow the best tuning. These make it practically impossible to calibrate consumer displays.

It is noted that the present methods and systems do not merely optimize content adaptation to a target display, which merely create the “best” picture by fully utilizing the capability of the display. By applying one or more disclosed techniques, one can achieve consistency, or reduce variation, between two displays that may exhibit different capabilities in different environments while showing a same image.

Practically, such variation exists between displays even in a same room. It is common to perceive differences when a user displays a picture on a laptop while also having it presented on a TV through e.g., Miracast. A large signage comprising multiple displays or screens of same model will face the challenge of ensuring that all the screens are presenting visual content with a minimal variation. When those screens are put next to each other, small variations become more easily discernable. For instance, a red car moving across multiple screens, a flower is split-displayed in multiple screens, or the like will require high consistency among the screens in the presented and perceived visual quality. Calibration requires connection to screens through cables of USB, HDMI, or the like and access to factory menus and settings. Considering the challenges, a large signage setup once starting to show drifts will thus benefit from the present methods and systems for improving consistency without repeatedly going through the hassles in professional calibration.

In some embodiments, methods and systems are provided to improve the consistency of a same content item being presented and perceived on different displays. The present methods and systems are based on estimating the image processing including image enhancements, display settings, and modification for ambient conditions altogether. The estimated process is then inversely applied to the input image prior to the image processing.

The present methods and systems are differentiated from typical content adaptation that intends to create a presentation at the best capable display settings, which inherently introduces variations in the perceived images. The present methods and systems are rather optimized to reduce the variations, ensuring a consistent look of a picture among different displays.

Some exemplary factors to consider in the estimations include a small set of common filters, including adjustment in brightness, contrast, and saturation. Those adjustments or enhancements on a display have the most impact on the look of a picture. Other post-processing and enhancements applied to sharpness, noise reduction, or the like may also be considered and estimated. The objective is focused on estimating how much change has been applied to a picture, e.g., a 10% brightness rise, 15% saturation increase, or the like. Then the inverse of each compensates for the estimated amount of change.

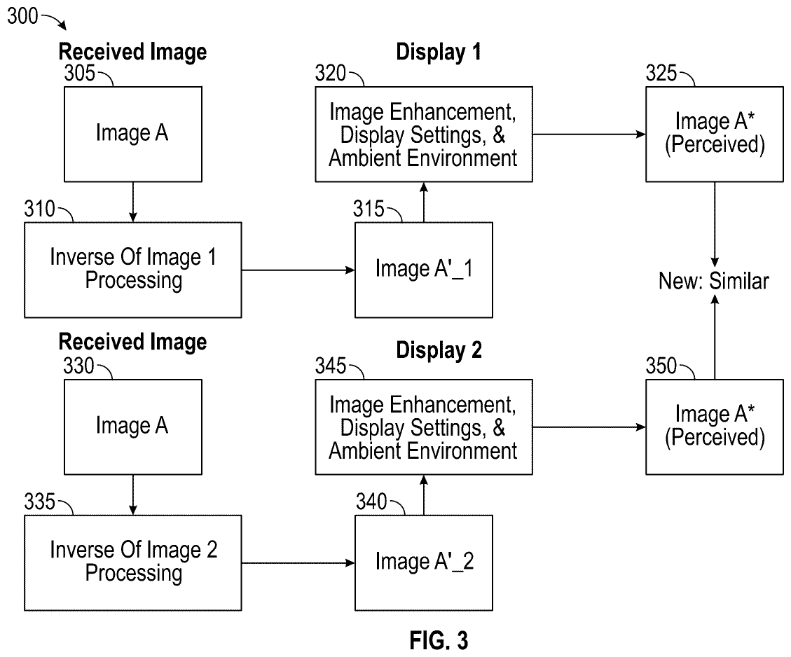

FIG. 3 is a flowchart 300 of a method for estimating and compensating of image processing, in accordance with some embodiments of the disclosure. An initial image (305, 330) is received by a system and displayed on two different displays, Display 1 (at 320) and Display 2 (at 345). On Display 1, the original image (Image A at 305) undergoes inverse processing (310) and is perceived as Image A′_1 (315). Similarly, on Display 2, the same original image (Image A at 330) undergoes inverse processing (335) and is perceived as Image A′_2 (340). After processing (at 320, 345), which may include image enhancement, adjustment of display settings, and adjustment of ambient environment, Image A* (325) is perceived at Display 1, and Image A* (350) is perceived at Display 2. Due to the inverse processing (310, 335), Image A* (325) at Display 1 is perceived to be similar to Image A* (350).

That is, as shown in FIG. 3, the image processing on the displays is estimated and then its inverse is applied to the input image. With this compensation, the presented images on both displays can be ultimately perceived with a minimum variation.

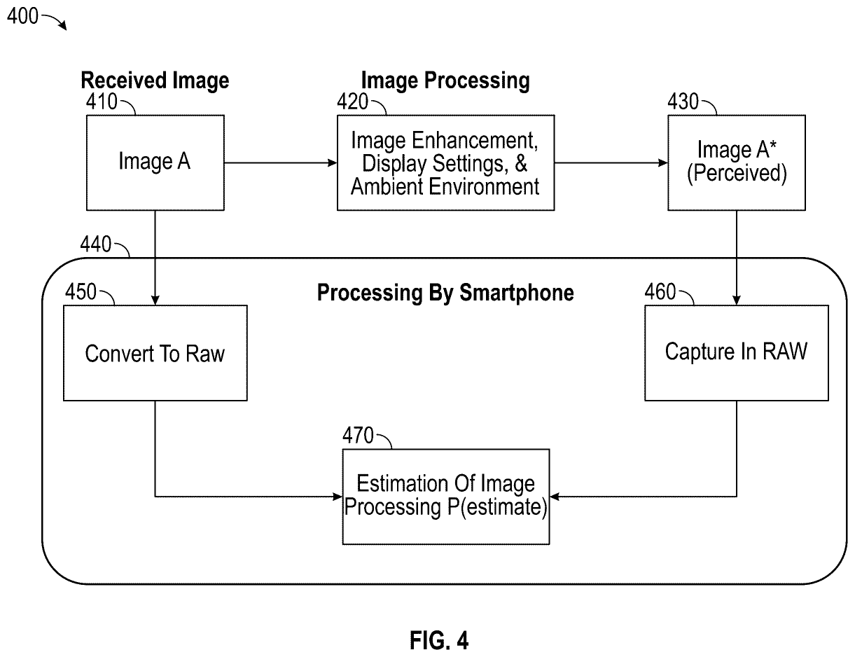

FIG. 4 is a flowchart 400 of a method for estimating image processing through a capturing device in RAW mode, in accordance with some embodiments of the disclosure. The initial Image A is received (at 410) by a system and undergoes image processing (420). The original image (Image A) is enhanced and perceived as Image A* (430). Processing is performed, for example, by a smartphone (at 440). The Image A is converted to RAW format (450). The Image A* is captured in RAW format (460). The RAW format is used, for example, to provide relatively high quality and flexibility in post-processing. Estimation methods (470) predict the effects of image processing on the image.

That is, as shown in FIG. 4, a smartphone is provided as a capturing device, and the estimation can be executed on the device (as shown) or through server processing. The capturing device, e.g., smartphone, may also generate images or test patterns that are sent to the target display. In other words, Image A is sent by the smartphone that captures the displayed image A*. To reduce and eliminate the effect by the camera ISP, the capture can be provided in the RAW mode. In that case, the source image A will also be converted to RAW, eliminating the effect by, e.g., color conversion, gamma correction, or the like. In this example, the estimation of image processing is in the RAW domain. Since the image processing on the display starts from a color graded image, the camera ISP processing may later be incorporated into the estimated image processing P(estimate).

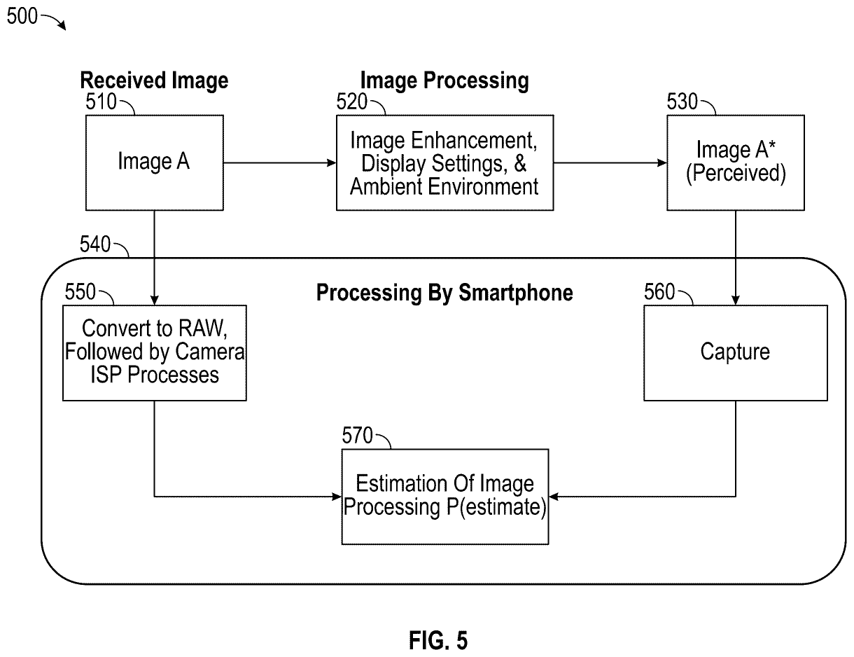

FIG. 5 is a flowchart 500 of another method for estimating image processing through a capturing device, in accordance with some embodiments of the disclosure. An initial Image A is received (at 510) by a system. The Image A undergoes image processing (at 520). The original image (Image A) is enhanced and perceived as Image A* (530). The Image A is converted to RAW format (550). At 550, camera ISP techniques are applied by the camera. The Image A* is captured (560). Estimation methods (570) predict the effects of image processing on the image. The image may be processed using a smartphone 540.

That is, in FIG. 5, the capture includes the camera ISP processing, while the source image A is first converted to RAW and then applied with the camera ISP. By converting to RAW and applying camera ISP, a variation between color grading and camera ISP is provided, since color grading at the creation of a source image may differ from the camera ISP. Note that, if the source image or test pattern is generated by the smartphone 540, this conversion may be waived.

In the examples of smartphone capturing in this mode, the camera's settings, e.g., shutter speed, ISO, and aperture, or the like can be configured in a conforming or fixed manner. This is to eliminate variations in the captures, often existing when auto settings are provided.

There are different combinations of variables and parameters in the estimation and compensation. Test images and patterns for the estimation of image processing after capture may go through normal processes of registration, perspective correction, or the like. The image or pattern may be created or zoomed in on the display so that a same pixel is duplicated in an area of, e.g., 2×2, 4×4, or the like. This provides flexibility in making the registration of captured images a lot easier.

The reference or target (i.e., Image A) in the estimation can be established in different ways. Since the source signal is available, its interpretation can assume a nominal reference monitor, e.g., peak luminance of 500-nit, black level of 0.05-nit, color gamut of P3, gamma of 2.2, or the like under an ambient of 100-nit in a viewing environment. Note that, this is not seen by the capturing device. Other combinations of nominal reference can be made in the case of considering a common denominator of multiple displays, or among multiple participants. In the case of multi-screen signage, a common reference among displays can be readily available. In more general applications, the captures of displayed images can provide an estimate of display capabilities, and a nominal reference or target can be defined for the estimated capabilities. For each visual content item, there may be multiple references defined for different ranges of display capabilities, and the reference can change for each range of displays. The selection of nominal references can be automatic, or by user selection after the system detects and presents options. In the case of two remote participants sharing the same content, the system can detect and determine a common denominator if both choose to have a consistent look of the visual.

In the case of a smartphone capturing a picture from a TV screen, ambient light reflection, glare, or other effects may be detected and removed from images and video by known technology. This is to provide a better captured image to improve the results of estimation processes.

The estimation and compensation may be executed iteratively considering the dynamics and high nonlinearity of such image processing with the display internal and external variables involved.

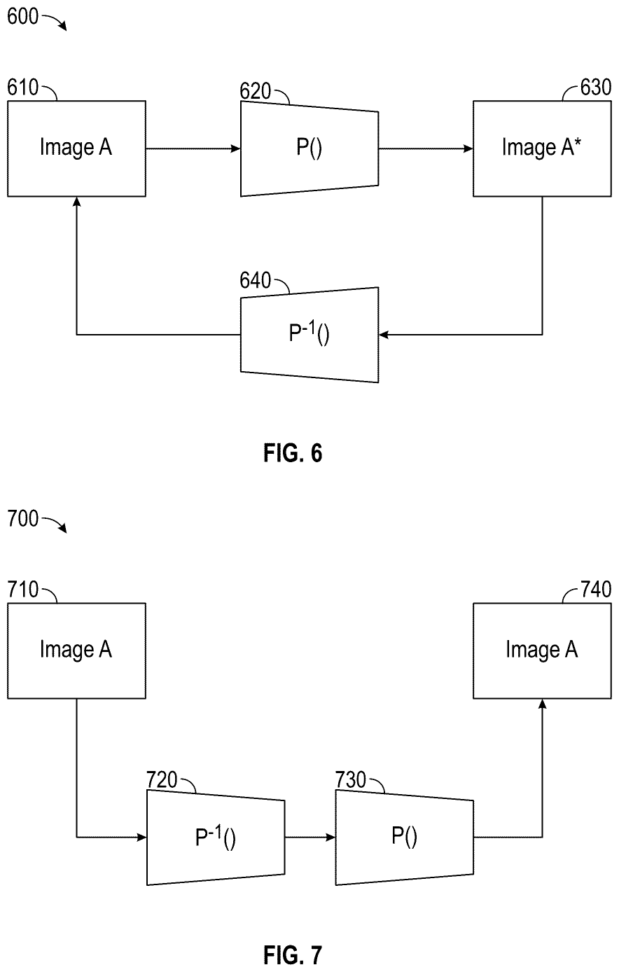

FIG. 6 is a flowchart 600 of a method for estimating or training for the forward and inverse of image processing, in accordance with some embodiments of the disclosure. The original image (Image A at 610) undergoes processing represented by the function P( ) (620). The enhanced image after processing is Image A* (at 630). The inverse processing function P⁻¹( ) (640) is applied to retrieve the original Image A.

That is, as illustrated in FIG. 6, a neural network or similar architecture is trained from the two input images, and the forward P( ) and/or the inverse P⁻¹( ) of image processing can be learned. Note that P( ) approximates the image processing while P⁻¹( ) approximates its inversion. If image processing causes information loss, e.g., by clamping, the inversion may become more difficult. However, the use of P( ) in FIG. 6 may help to eliminate some clamping if the clamping exists or is known in an estimated operator of P( ). In other words, after estimating P( ) as a sequence of operators, it can identify possible clamping in each operator and remove the clamping when generating a version of Image A* through a simulation of the image processing. This may help improve the estimation of the inversion.

The above adjustment of P( ) is a notable improvement over some existing approaches. Without adjusting, e.g., the clamping processes, the estimate of inverse P⁻¹( ) may result in a change of, e.g., brightness increase by 14%. This is based on many pixel values, after an increase in brightness, being clipped to a maximum (e.g., 255 in 8-bit). Such a mapping of many-to-one will result in one-to-many in the reverse, which is generally very difficult to estimate. Pixel values of 230 and 240, after an increase of 15%, will both become 255. If the clamping is removed, the cases of one-to-many can be reduced in the estimation. Without clamping, pixel value of 230 becomes 264.5 and 240 becomes 276. In the above example, the estimate of inverse P⁻¹( ) may suggest a brightness increase by 15% instead. Note that, the example of brightness increase is only one of the multiple operators that collectively contribute to changes in contrast, saturation, or the like.

FIG. 7 is a flowchart 700 of a method for processing applied to achieve consistency with a reference, in accordance with some embodiments of the disclosure. The original image (Image A at 710) undergoes inverse processing represented by the function P⁻¹( ) (720). The processing function P( ) (730) is then applied to the image. The Image A after processing and inverse processing is provided (at 740).

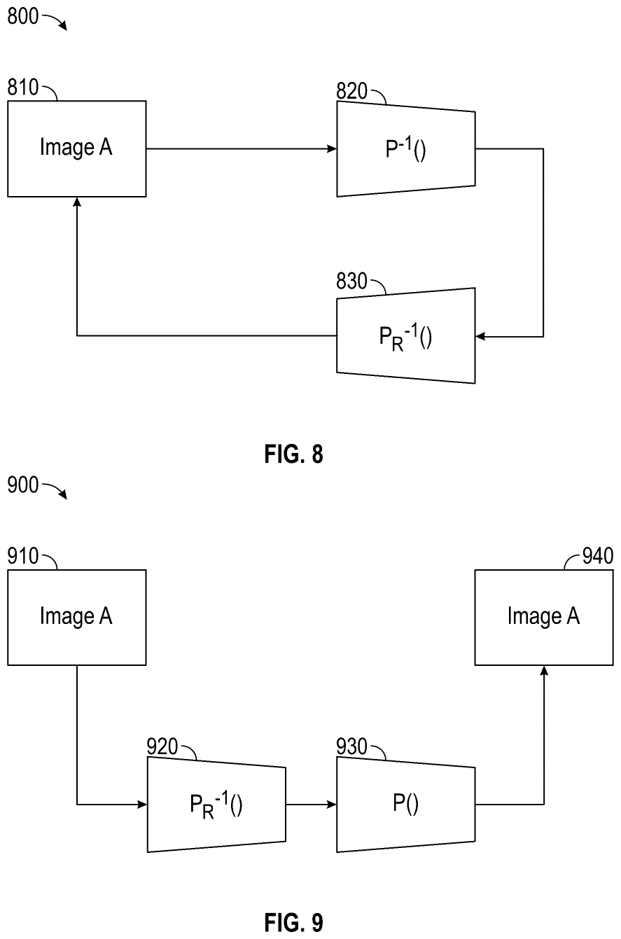

That is, in FIG. 7, the processes provide compensation, i.e., Inverse P⁻¹( ), to the image processing, i.e., Forward P( ). Since those processes are highly nonlinear, such compensation may not perfectly cancel the effect from image processing. In other words, the input images to both the forward and inverse processes are different from those shown in FIG. 6, and discrepancy or drift may be expected. This can be improved or refined by the processes presented in FIG. 8.

FIG. 8 is a flowchart 800 of a method for refining an inverse process, in accordance with some embodiments of the disclosure. The original image (Image A at 810) undergoes inverse processing represented by the function P⁻¹( ) (820). The processing function P_{R}⁻¹(830) is then applied to the image. Fixed processing techniques serve as inputs to refining inverse processes.

Once the refined inverse process P_{R-1}( ) is obtained, it can replace the inverse process P⁻¹( ) in FIG. 7. The new flow is shown in FIG. 9.

FIG. 9 is a flowchart 900 of a method for applying processes, with a replacement of the refined inverse process, to achieve consistency with a reference, in accordance with some embodiments of the disclosure. The original image (Image A at 910) undergoes processing represented by the function P_{R}⁻¹( ) (920) and the function P( ) (930). The Image A after processing and inverse processing is provided (at 940). The refinement process may be iterated to achieve the best approximation or the minimal deviation in the outcome of Image A. The iteration may be executed as a combination of both FIG. 8 and FIG. 9.

In the application of the processes in FIG. 7 and FIG. 9, the forward process P( ) represents the image processing as denoted in the illustrations of FIGS. 3, 4, and 5. Therefore, for example, it is a fixed operation after it is learned through training as shown in FIG. 6.

In the case of integrating the present methods and systems into a signage system, the estimated inverse process for each screen can be part of the pre-processing prior to the portion of a split-screen image being delivered to the screen. This is a common module where a large image or video frame is split to fit in each screen and then transmitted for presentation.

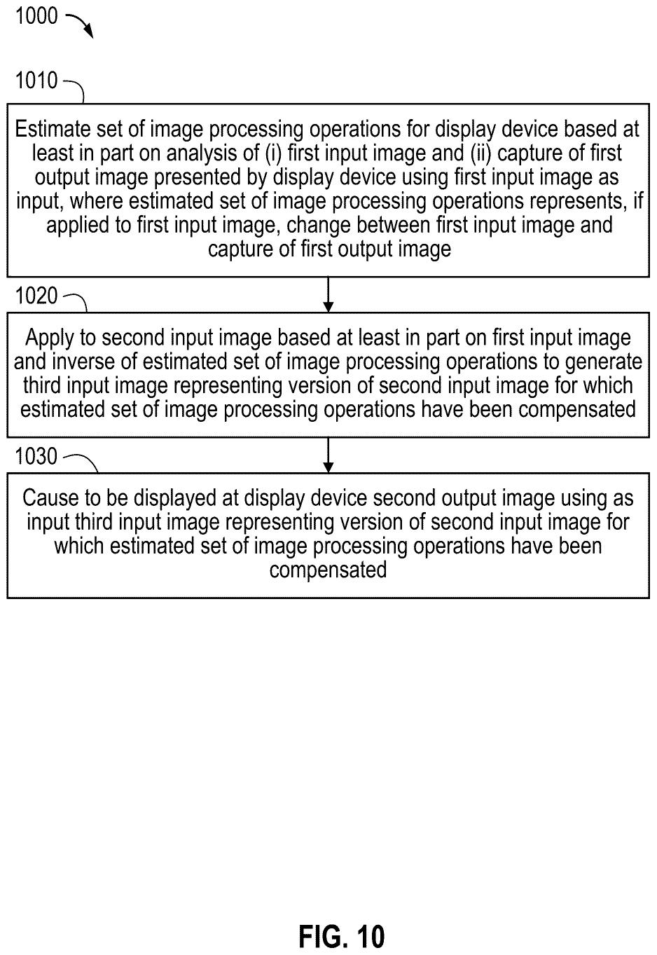

FIG. 10 is a flowchart 1000 of a method for estimating image processing operations based on an analysis of input and output images, applying the inverse of these operations to a second input image derived from the first, and displaying the compensated image on the device, in accordance with some embodiments of the disclosure. For example, the method comprises estimating 1010 a set of image processing operations for a display device based at least in part on an analysis of (i) a first input image and (ii) a capture of a first output image presented by the display device using the first input image as input, wherein the estimated set of image processing operations represents, if applied to the first input image, a change between the first input image and the capture of the first output image. Also, for example, the method comprises applying 1020 to a second input image based at least in part on the first input image and an inverse of the estimated set of image processing operations to generate a third input image representing a version of the second input image for which the estimated set of image processing operations have been compensated. Further, for example, the method comprises causing 1030 to be displayed at the display device a second output image using as input the third input image representing the version of the second input image for which the estimated set of image processing operations have been compensated. In addition, for example, the third input image is an intermediate image. Moreover, for example, the method comprises applying an image enhancement, a display setting, and an ambient factor relative to the third input image after applying to the second input image the inverse of the estimated set of image processing operations to generate the third input image. Furthermore, for example, the estimated set of processing operations (e.g., of step 1010) comprises adjustments in color, brightness, contrast, and saturation. Additionally, for example, the method comprises iteratively adjusting the estimating the set of image processing operations. Still further, for example, the method comprises iteratively adjusting the generating the third input image. Even further, for example, the estimated set of processing operations (e.g., of step 1010) comprises capturing an image with an image capture device operating in a RAW image format mode.

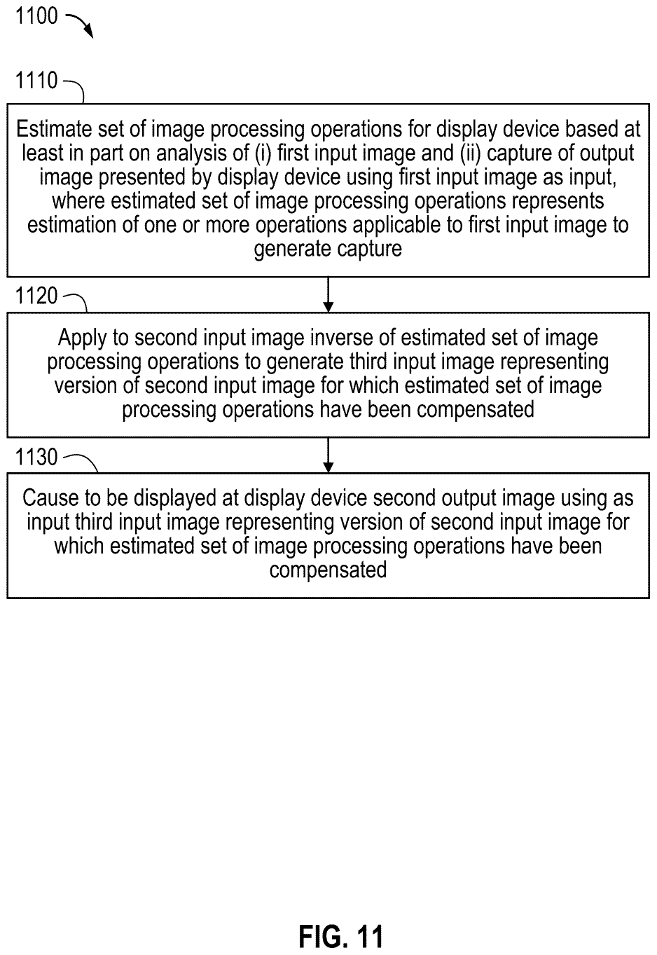

FIG. 11 is a flowchart 1100 of a method for estimating image processing operations based on an analysis of input and output images, applying the inverse of these operations to a second input image to generate a compensated version, and displaying the resulting image on the device, in accordance with some embodiments of the disclosure.

For example, the method comprises estimating 1110 a set of image processing operations for a display device based at least in part on an analysis of (i) a first input image and (ii) a capture of an output image presented by the display device using the first input image as input, wherein the estimated set of image processing operations represents an estimation of one or more operations applicable to the first input image to generate the capture. Also, for example, the method comprises applying 1120 to a second input image an inverse of the estimated set of image processing operations to generate a third input image representing a version of the second input image for which the estimated set of image processing operations have been compensated. Further, for example, the method comprises causing 1130 to be displayed at the display device a second output image using as input the third input image representing the version of the second input image for which the estimated set of image processing operations have been compensated. In addition, for example, the applying 1120 the inverse of the estimated set of image processing operations to generate the third input image representing the version of the second input image for which the estimated set of image processing operations have been compensated comprises estimation of processing parameters. Moreover, for example, the estimating 1110 the set of image processing operations comprises at least one of estimating application of the image processing by the display device to the second input image; or adjusting at least one of brightness, contrast, color, saturation, sharpness, or noise reduction. Furthermore, for example, the applying 1120 the inverse of the estimated set of image processing operations to generate the third input image representing the version of the second input image for which the estimated set of image processing operations have been compensated comprises reversing effects of the estimated application of the processing operations. Additionally, for example, the applying 1120 the inverse of the estimated set of image processing operations to generate the third input image representing the version of the second input image for which the estimated set of image processing operations have been compensated comprises generation of a compensated image.

Still further, for example, the applying 1120 the inverse of the estimated set of image processing operations to generate the third input image representing the version of the second input image for which the estimated set of image processing operations have been compensated comprises iterative refinement by repeatedly adjusting the estimating the set of the image processing operations and applying the inverse process until a desired consistency is achieved. Even further, for example, the applying 1120 the inverse of the estimated set of image processing operations to generate the third input image representing the version of the second input image for which the estimated set of image processing operations have been compensated comprises a neural network configured to estimate and compensate for the image processing operations applicable by the display device.

Also, for example, in some embodiments, the estimated set of image processing operations of the estimating 1110 refers to a set of operations that, hypothetically, if applied to the first input image, would result in the capture. This “capture” involves estimating processes on the display device. The estimated processes are applicable to the first input image to generate the displayed image and/or the output image presented by the display device. In this context, the camera ISP, which may be included in the capturing device, is not part of the estimated processes. Using a RAW mode for image acquisition improves the process because the RAW mode excludes the camera ISP. In a non-RAW mode, the camera ISP is expected to be reverted, approximately going back to RAW mode.

Further, in some instances, a camera captures an image in a RAW mode, while in other instances, it does not. The system may convert the RAW mode data to a non-RAW mode image.

In addition, for example, the accuracy or precision of the estimate of the set of operations is tested by applying the estimated set of operations to the first input image to generate a test image. If displayed at a reference monitor, the test image should look like what is displayed on the display that presented the image represented in the capture. The test image is then displayed at the reference monitor and compared to the output image at the display to determine the difference between the two. Ideally, this difference is zero, indicating a good estimate. If the difference is above a threshold, modifications to the estimated set of operations may be attempted to generate a new test image.

Moreover, for example, the analysis (e.g., of step 1110) of (i) the first input image and (ii) the capture of the output image presented by the display device comprises at least one of: capturing the capture of the output image using a camera or sensor; or comparing the capture of the output image with the first input image to identify differences attributable to processing operations of the display device.

Furthermore, for example, the estimated set of image processing operations (e.g., of step 1110) comprises at least one of: identifying one or more image processing applications utilized by the display device; or quantifying an impact of each identified one or more image processing applications on the first input image.

Additionally, for example, a software module is configured to perform the applying 1120 the inverse of the estimated set of image processing operations and apply the inverse of the estimated set of image processing operations to the second input image.

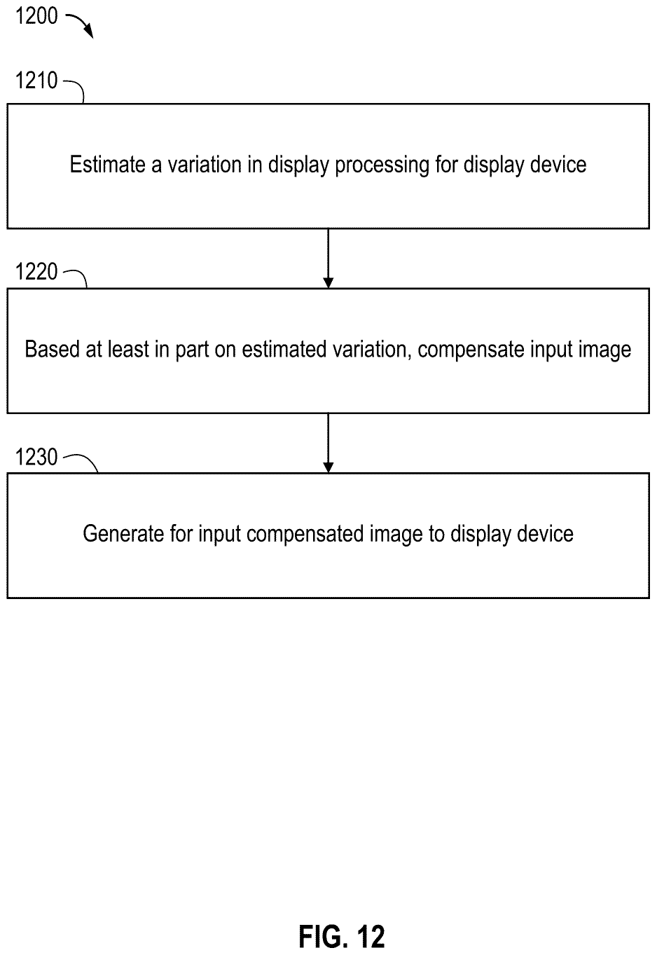

FIG. 12 is a flowchart 1200 of a method for estimating variations in display processing parameters, compensating an input image based on these variations, and generating the compensated image for display, in accordance with some embodiments of the disclosure. For example, the method comprises estimating 1210 a variation in display processing for a display device. Also, for example, the method comprises, based at least in part on the estimated variation, compensating 1220 an input image. Further, for example, the method comprises generating 1230 for input the compensated image to the display device. In addition, for example, the display processing (e.g., of step 1210) comprises panel quality, backlight, and polarizer variations. Moreover, for example, the display processing (e.g., of step 1210) comprises adjustments in color, brightness, contrast, and saturation. Furthermore, for example, the estimating 1210 the variation in the display processing for the display device comprises capturing an image of the display device with an image capture device. Additionally, for example, the estimating 1210 the variation in the display processing for the display device comprises generating a test pattern with the image capture device. Still further, for example, the estimating 1210 the variation in the display processing for the display device comprises transmitting the generated test pattern to the display device. Even further, for example, the method comprises configuring camera settings of the image capture device. Yet further, for example, the estimating 1210 the variation in the display processing for the display device and the generating 1230 for input the compensated image to the display device are performed on the image capture device. Further still, for example, the estimating 1210 the variation in the display processing for the display device and the generating 1230 for input the compensated image to the display device are performed on a computing resource remote from the display device.

Also, for example, the compensating 1220 the input image comprises dynamically compensating the input image based at least in part on a real-time estimation of the display processing parameters.

Further, for example, the display device comprises a multi-screen device configured to display on each screen a portion of the compensated image.

In addition, for example, the estimating 1210 the variation in the display processing for the display device comprises an inverse process for each screen of the multi-screen device.

Moreover, for example, the method comprises pre-processing the estimating 1210 the variation in the display processing for the display device prior to the generating 1230 for input the compensated image to the display device.

Furthermore, for example, a common module performs the pre-processing of the estimating the variation in the display processing for the display device prior to the generating for input the compensated image to the display device. Additionally, for example, a common module splits a large image or video frame to fit each screen of the multi-screen device. Still further, for example, a common module transmits each portion of the compensated image to the respective screen of the multi-screen device.

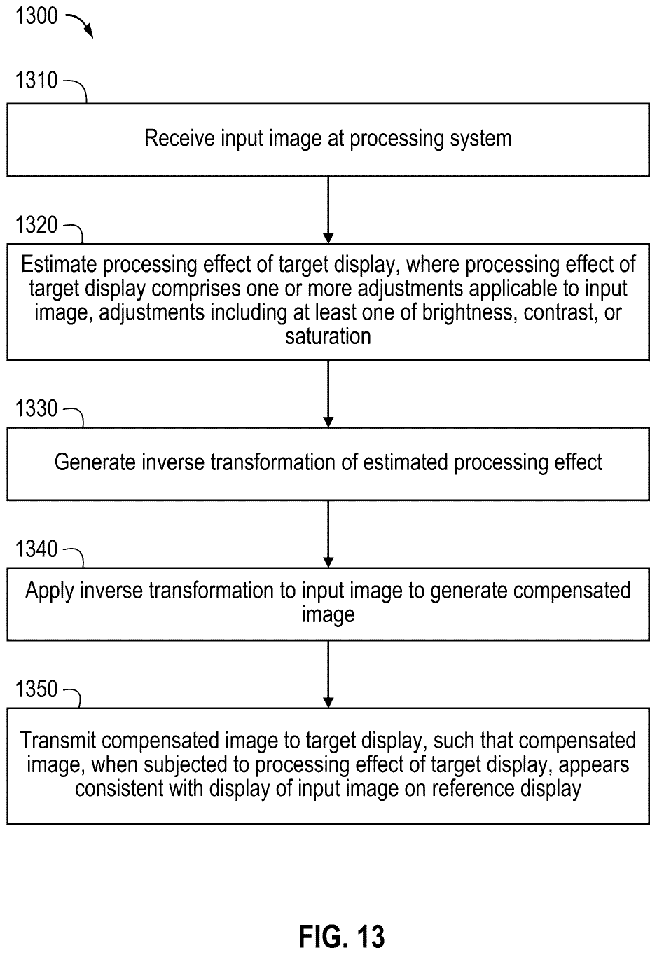

FIG. 13 is a flowchart 1300 of a method for ensuring consistent visual content across multiple displays by estimating and inversely transforming the processing effects of a target display, then applying this transformation to an input image before transmitting it to the target display, in accordance with some embodiments of the disclosure. For example, the method comprises receiving 1310 an input image at a processing system. Also, for example, the method comprises estimating a processing effect of a target display. Further, for example, the processing effect of the target display comprises one or more adjustments applicable to the input image, the adjustments including at least one of brightness, contrast, or saturation. In addition, for example, the method comprises generating 1330 an inverse transformation of the estimated processing effect. Moreover, for example, the method comprises applying 1340 the inverse transformation to the input image to generate a compensated image. Furthermore, for example, the method comprises transmitting 1350 the compensated image to the target display, such that the compensated image, when subjected to the processing effect of the target display, appears consistent with display of the input image on a reference display. Additionally, for example, a smartphone sends images or test patterns to the target display for display, and the displayed images or test patterns are captured by the smartphone. Still further, for example, the capture is performed in a RAW mode.

Throughout the present disclosure, in some embodiments, determinations, predictions, likelihoods, and the like are determined with one or more predictive models. In some embodiments, the model receives various forms of data about users, media content items, devices, servers, and the like. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, digital content items, devices, and the like. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

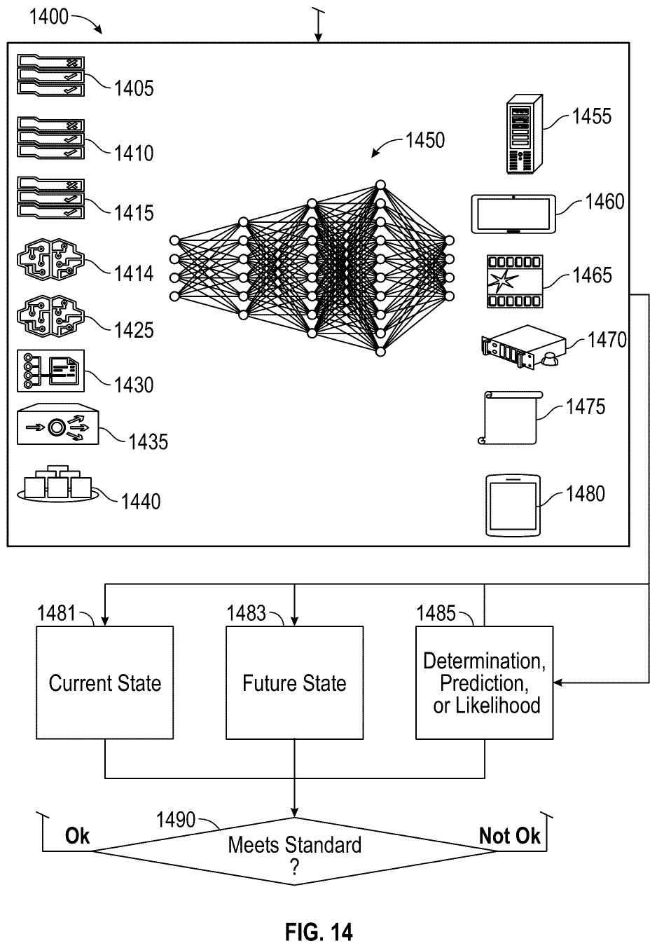

For example, FIG. 14 depicts a predictive model of an AI system 1400. The AI system 1400 includes a predictive model 1450 in some embodiments. The predictive model 1450 receives as input various forms of data about one, more or all the users, media content items, devices, servers, and data described in the present disclosure. The predictive model 1450 performs analysis based on at least one of hard rules, learning rules, hard models, learning models, usage data, load data, analytics of the same, metadata, profile information, combinations of the same, or the like. The predictive model 1450 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1450 is based on input including at least one of a hard rule 1405, a user-defined rule 1410, a rule defined by a content provider 1415, a hard model 1420, a learning model 1425, combinations of the same, or the like.

The predictive model 1450 receives as input usage data 1430. The predictive model 1450 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 1450 receives as input load-balancing data 1435. The predictive model 1450 is based on at least one of load data of the display device, load data of the requesting media device, load data of the media content item, load data of the communication system or network, load data of the profile, load data of the media device, combinations of the same, or the like.

The predictive model 1450 receives as input metadata 1440. The predictive model 1450 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 1450 is trained with data. The training data is developed in some embodiments using one or more data processes including but not limited to data selection, data sourcing, and data synthesis. The predictive model 1450 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1450 is trained in some embodiments with one or more machine learning approaches including but not limited to supervised learning, unsupervised learning, semi-supervised learning, reinforcement learning, and dimensionality reduction. The predictive model 1450 in some embodiments includes regression analysis including analysis of variance (ANOVA), linear regression, logistic regression, ridge regression, and/or time series. The predictive model 1450 in some embodiments includes classification analysis including decision trees and/or neural networks. In FIG. 14, a depiction of a multi-layer neural network is provided as a non-limiting example of a predictive model 1450, the neural network including an input layer (left side), three hidden layers (middle), and an output layer (right side) with 32 neurons and 192 edges, which is intended to be illustrative, not limiting. The predictive model 1450 is based on data engineering and/or modeling processes. The data engineering processes include exploration, cleaning, normalizing, feature engineering, and scaling. The modeling processes include model selection, training, evaluation, and tuning. The predictive model 1450 is operationalized using registration, deployment, monitoring, and/or retraining processes.

The predictive model 1440 is configured to output results to a device or multiple devices. The device includes means for performing one, more, or all the features referenced herein of the systems, methods, processes, and outputs of one or more of FIGS. 1-13, in any suitable combination. The device is at least one of a server 1455, a tablet 1460, a media display device 1465, a network-connected computer 1470, a media device 1475, a computing device 1480, combinations of the same, or the like.

The predictive model 1450 is configured to output a current state 1481, and/or a future state 1483, and/or a determination, a prediction, or a likelihood 1485, and the like. The current state 1481, and/or the future state 1483, and/or the determination, the prediction, or the likelihood 1485, and the like may be compared 1490 to a predetermined or determined standard. In some embodiments, the standard is satisfied (1490=OK) or rejected (1490=NOT OK). If the standard is satisfied or rejected, the AI system 1400 outputs at least one of the current state, the future state, the determination, the prediction, the likelihood to any device or module disclosed herein, combinations of the same, or the like. In some embodiments, the predictive model 1450 incorporates one or more LLMs.

In some embodiments, an AI system 1400 comprises a predictive model and/or predictive engine. For example, the predictive model/engine is modeled, trained, and utilized to predict information for one or more portions of the above-described methods and systems. Also, for example, the AI system 1400 is configured to ensure consistent visual content presentation across different display devices by compensating for the processing each display applies to the image. Further, for example, a predictive model 1450 receives diverse forms of data, including usage data, load-balancing data, metadata, and user interaction data. In addition, for example, the predictive model 1450, utilizes hard rules, learning rules, hard models, learning models, and combinations thereof to predict future states of devices. Moreover, for example, the predictive model 1450 is trained using various data processes, analytical processes, and machine learning approaches, and is operationalized through registration, deployment, monitoring, and retraining processes.

Furthermore, for example, the AI system 1400 processes metadata from streaming services, media devices, communication systems, and user profiles to estimate the processing parameters applied by display devices, such as brightness, contrast, color, saturation, sharpness, and noise reduction. Additionally, for example, the AI system 1400 analyzes the first input image and captures the output image presented by the display device to estimate the set of image processing operations. Still further, for example, the AI system 1400 applies an inverse of the estimated processing operations to a second input image to generate a third input image, compensating for the changes made by the display device. Even further, for example, the AI system 1400 is configured for iterative refinement, where the estimation is repeatedly adjusted and the inverse process applied until the desired consistency is achieved. Yet further, for example, neural networks may be configured for this estimation and compensation.

Also, for example, a trained model outputs results to various devices, including servers, tablets, media display devices, network-connected computers, and the like. Further, for example, the outputs include current state, future state, determinations, predictions, or likelihoods, which are compared to predetermined standards. In addition, for example, the AI system 1400 is configured for consistent visual content presentation by identifying and quantifying the impact of image processing applications used by the display device and applying the inverse of these operations to input images. Moreover, for example, the AI system 1400 comprises cameras and/or sensors to capture output images for analysis and may comprise intermediate image processing, applying enhancements, display settings, and ambient factors after inverse processing. Furthermore, the AI system 1400 is configured for uniform visual content presentation across various consumer and professional display devices by compensating for differences in hardware, settings, and image processing techniques.

In some embodiments, a communication system is provided including a computing device, a server, and a communication network. Both the server and the communication network can exist in multiple forms and can connect directly or indirectly. The computing device includes control circuitry, a display, and input/output (I/O) circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit inputs to the remote server for processing. Both the server and the computing device can transmit and receive content via the communication network or directly, and the processing circuitry receives the user input and converts it to digital signals.

In some embodiments, the system is a distributed network architecture with an edge device (a type of computing device 1502), a cloud server (a type of server 1504), and an internet of things (IoT) network (a type of communication network 1506). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

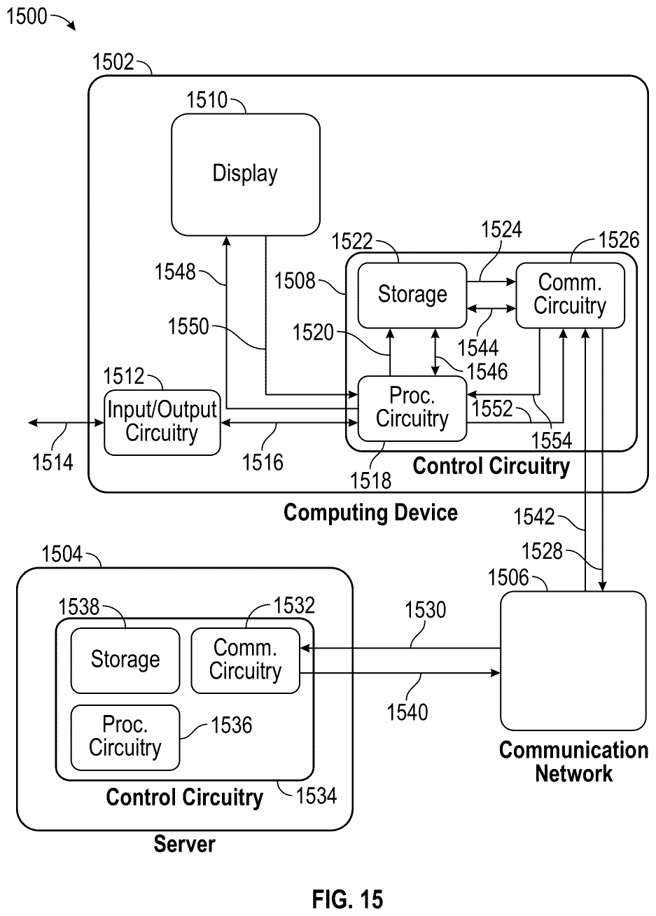

FIG. 15 depicts a block diagram of system 1500, in accordance with some embodiments. The system is shown to include computing device 1502, server 1504, and a communication network 1506. It is understood that while a single instance of a component may be shown and described relative to FIG. 15, additional embodiments of the component may be employed. For example, server 1504 may include, or may be incorporated in, more than one server. Similarly, communication network 1506 may include, or may be incorporated in, more than one communication network. Server 1504 is shown communicatively coupled to computing device 1502 through communication network 1506. While not shown in FIG. 15, server 1504 may be directly communicatively coupled to computing device 1502, for example, in a system absent or bypassing communication network 1506.

Communication network 1506 may include one or more network systems, such as, without limitation, the internet, LAN, Wi-Fi, wireless, or other network systems suitable for audio processing applications. The system 1500 of FIG. 15 excludes server 1504, and functionality that would otherwise be implemented by server 1504 is instead implemented by other components of the system depicted by FIG. 15, such as one or more components of communication network 1506. In still other embodiments, server 1504 works in conjunction with one or more components of communication network 1506 to implement certain functionality described herein in a distributed or cooperative manner. Similarly, the system depicted by FIG. 15 excludes computing device 1502, and functionality that would otherwise be implemented by computing device 1502 is instead implemented by other components of the system depicted by FIG. 15, such as one or more components of communication network 1506 or server 1504 or a combination of the same. In other embodiments, computing device 1502 works in conjunction with one or more components of communication network 1506 or server 1504 to implement certain functionality described herein in a distributed or cooperative manner.

Computing device 1502 includes control circuitry 1508, display 1510 and I/O circuitry 1512. Control circuitry 1508 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 1508 in turn includes communication circuitry 1526, storage 1522 and processing circuitry 1518. Either of control circuitry 1508 and 1534 may be utilized to execute or perform any or all the systems, methods, processes, and outputs of one or more of FIGS. 1-14, or any combination of steps thereof (e.g., as provided by processing circuitries 1518 and 1536, respectively).

In addition to control circuitry 1508 and 1534, computing device 1502 and server 1504 may each include storage (storage 1522, and storage 1538, respectively). Each of storages 1522 and 1538 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1522 and 1538 may be used to store several types of content, metadata, and/or other types of data. Non-volatile memory may also be used (e.g., to launch a boot-up routine and other instructions). Cloud-based storage may be used to supplement storages 1522 and 1538 or instead of storages 1522 and 1538. In some embodiments, a user profile and messages corresponding to a chain of communication may be stored in one or more of storages 1522 and 1538. Each of storages 1522 and 1538 may be utilized to store commands, for example, such that when each of processing circuitries 1518 and 1536, respectively, are prompted through control circuitries 1508 and 1534, respectively. Either of processing circuitries 1518 or 1536 may execute any of the systems, methods, processes, and outputs of one or more of FIGS. 1-14, or any combination of steps thereof.

In some embodiments, control circuitry 1508 and/or 1534 executes instructions for an application stored in memory (e.g., storage 1522 and/or storage 1538). Specifically, control circuitry 1508 and/or 1534 may be instructed by the application to perform the functions discussed herein. In some embodiments, any action performed by control circuitry 1508 and/or 1534 may be based on instructions received from the application. For example, the application may be implemented as software or a set of and/or one or more executable instructions that may be stored in storage 1522 and/or 1538 and executed by control circuitry 1508 and/or 1534. The application may be a client/server application where only a client application resides on computing device 1502, and a server application resides on server 1504.

The application may be implemented using any suitable architecture. For example, it may be a stand-alone application wholly implemented on computing device 1502. In such an approach, instructions for the application are stored locally (e.g., in storage 1522), and data for use by the application is downloaded on a periodic basis (e.g., from an out-of-band feed, from an internet resource or using another suitable approach). Control circuitry 1508 may retrieve instructions for the application from storage 1522 and process the instructions to perform the functionality described herein. Based on the processed instructions, control circuitry 1508 may determine a type of action to perform based at least in part on input received from I/O circuitry 1512 or from communication network 1506.

The computing device 1502 is configured to communicate with an I/O device (not shown) via the I/O circuitry 1512. In some embodiments, the user input 1514 is received from the I/O device. A wired and/or wireless connection between the I/O circuitry 1512 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 1508 may include communication circuitry suitable for communicating with an application server (e.g., server 1504) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 1506). In another example of a client/server-based application, control circuitry 1508 runs a web browser that interprets web pages provided by a remote server (e.g., server 1504). For example, the remote server may store the instructions for the application in a storage device.

The remote server may process the stored instructions using circuitry (e.g., control circuitry 1534) and/or generate displays. Computing device 1502 may receive the displays generated by the remote server and may display the content of the displays locally via display 1510. For example, display 1510 may be utilized to present a string of characters. This way, the processing of the instructions is performed remotely (e.g., by server 1504) while the resulting displays, such as the display windows described elsewhere herein, are provided locally on computing device 1504. Computing device 1502 may receive inputs from the user via input/output circuitry 1512 and transmit those inputs to the remote server for processing and generating the corresponding displays.

Alternatively, computing device 1502 may receive inputs from the user via input/output circuitry 1512 and process and display the received inputs locally, by control circuitry 1508 and display 1510, respectively. For example, input/output circuitry 1512 may correspond to a keyboard and/or a set of and/or one or more speakers/microphones which are used to receive user inputs (e.g., input as displayed in a search bar or a display of FIG. 15 on a computing device). Input/output circuitry 1512 may also correspond to a communication link between display 1510 and control circuitry 1508 such that display 1510 updates based at least in part on inputs received via input/output circuitry 1512 (e.g., simultaneously update what is shown in display 1510 based on inputs received by generating corresponding outputs based on instructions stored in memory via a non-transitory, computer-readable medium).

Server 1504 and computing device 1502 may transmit and receive content and data such as media content via communication network 1506. For example, server 1504 may be a media content provider, and computing device 1502 may be a smart television configured to download or stream media content, such as a live news broadcast, from server 1504. Control circuitry 1534, 1508 may send and receive commands, requests, and other suitable data through communication network 1506 using communication circuitry 1532, 1526, respectively. Alternatively, control circuitry 1534, 1508 may communicate directly with each other using communication circuitry 1532, 1526, respectively, avoiding communication network 1506.

It is understood that computing device 1502 is not limited to the embodiments and methods shown and described herein. In nonlimiting examples, computing device 1502 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1502 receives user input 1514 at input/output circuitry 1512. For example, computing device 1502 may receive a user input such as a user swipe or user touch. It is understood that computing device 1502 is not limited to the embodiments and methods shown and described herein.

User input 1514 may be received from a user selection-capturing interface that is separate from device 1502, such as a remote-control device, trackpad, or any other suitable user movement-sensitive, audio-sensitive or capture devices, or as part of device 1502, such as a touchscreen of display 1510. Transmission of user input 1514 to computing device 1502 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 1512 may include a physical input port such as a 12.5 mm (0.4915 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 1518 may receive user input 1514 from input/output circuitry 1512 using communication path 1516. Processing circuitry 1518 may convert or translate the received user input 1514 that may be in the form of audio data, visual data, gestures, or movement to digital signals. In some embodiments, input/output circuitry 1512 performs the translation to digital signals. In some embodiments, processing circuitry 1518 (or processing circuitry 1536, as the case may be) conducts disclosed processes and methods.

Processing circuitry 1518 may provide requests to storage 1522 by communication path 1520. Storage 1522 may provide requested information to processing circuitry 1518 by communication path 1546. Storage 1522 may transfer a request for information to communication circuitry 1526 which may translate or encode the request for information to a format receivable by communication network 1506 before transferring the request for information by communication path 1528. Communication network 1506 may forward the translated or encoded request for information to communication circuitry 1532, by communication path 1530.

At communication circuitry 1532, the translated or encoded request for information, received through communication path 1530, is translated or decoded for processing circuitry 1536, which will provide a response to the request for information based on information available through control circuitry 1534 or storage 1538, or a combination thereof. The response to the request for information is then provided back to communication network 1506 by communication path 1540 in an encoded or translated format such that communication network 1506 forwards the encoded or translated response back to communication circuitry 1526 by communication path 1542.

At communication circuitry 1526, the encoded or translated response to the request for information may be provided directly back to processing circuitry 1518 by communication path 1554 or may be provided to storage 1522 through communication path 1544, which then provides the information to processing circuitry 1518 by communication path 1546. Processing circuitry 1518 may also provide a request for information directly to communication circuitry 1526 through communication path 1552, where storage 1522 responds to an information request (provided through communication path 1520 or 1544) by communication path 1524 or 1546 that storage 1522 does not contain information pertaining to the request from processing circuitry 1518.

Processing circuitry 1518 may process the response to the request received through communication paths 1546 or 1554 and may provide instructions to display 1510 for a notification to be provided to the users through communication path 1548. Display 1510 may incorporate a timer for providing the notification or may rely on inputs through input/output circuitry 1512 from the user, which are forwarded through processing circuitry 1518 through communication path 1548, to determine how long or in what format to provide the notification. When display 1510 determines the display has been completed, a notification may be provided to processing circuitry 1518 through communication path 1550.

The communication paths provided in FIG. 15 between computing device 1502, server 1504, communication network 1506, and all subcomponents depicted are examples and may be modified to reduce processing time or enhance processing capabilities for each step in the processes disclosed herein by one skilled in the art.

### Terminology

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud-computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example, within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random-access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method comprising:
estimating a set of image processing operations for a display device based at least in part on an analysis of (i) a first input image and (ii) a capture of a first output image presented by the display device using the first input image as input, wherein the estimated set of image processing operations defines a processing effect of the display device such that applying the estimated set of image processing operations to the first input image generates an approximation of the capture of the first output image;
applying to a second input image based at least in part on the first input image an inverse of the estimated set of image processing operations to generate a third input image representing a version of the second input image for which the estimated set of image processing operations have been compensated; and
causing to be displayed at the display device a second output image using as input the third input image representing the version of the second input image for which the estimated set of image processing operations have been compensated.

2. The method of claim 1, wherein the third input image is an intermediate image, the method comprising:
applying an image enhancement, a display setting, and an ambient factor relative to the third input image after applying to the second input image the inverse of the estimated set of image processing operations to generate the third input image.

3. The method of claim 1, wherein the estimated set of image processing operations comprises adjustments in color, brightness, contrast, and saturation.

4. The method of claim 1, comprising iteratively adjusting the estimating the set of image processing operations, and the generating the third input image.

5. The method of claim 1, wherein the estimated set of image processing operations comprises capturing an image with an image capture device operating in a RAW image format mode.

6. A method comprising:
estimating a set of image processing operations for a display device based at least in part on an analysis of (i) a first input image and (ii) a capture of an output image presented by the display device using the first input image as input, wherein the estimated set of image processing operations defines a processing effect of the display device such that applying the estimated set of image processing operations to the first input image generates an approximation of the capture of the output image;
applying to a second input image an inverse of the estimated set of image processing operations to generate a third input image representing a version of the second input image for which the estimated set of image processing operations have been compensated; and
causing to be displayed at the display device a second output image using as input the third input image representing the version of the second input image for which the estimated set of image processing operations have been compensated.

7. The method of claim 6, wherein the applying the inverse of the estimated set of image processing operations to generate the third input image representing the version of the second input image for which the estimated set of image processing operations have been compensated comprises estimation of processing parameters.

8. The method of claim 7, wherein the estimating the set of image processing operations comprises:
estimating application of image processing by the display device to the second input image; and
adjusting at least one of brightness, contrast, color, saturation, sharpness, or noise reduction.

9. The method of claim 7, wherein the applying the inverse of the estimated set of image processing operations to generate the third input image representing the version of the second input image for which the estimated set of image processing operations have been compensated comprises reversing effects of the processing effect of the estimated set of image processing operations.

10. The method of claim 6, wherein the applying the inverse of the estimated set of image processing operations to generate the third input image representing the version of the second input image for which the estimated set of image processing operations have been compensated comprises generation of a compensated image.

11.-30. (canceled)

31. A system comprising circuitry configured to:
estimate a set of image processing operations for a display device based at least in part on an analysis of (i) a first input image and (ii) a first output image presented by the display device using the first input image as input, wherein the estimated set of image processing operations defines a processing effect of the display device such that applying the estimated set of image processing operations to the first input image generates an approximation of the first output image;
apply to a second input image based at least in part on the first input image an inverse of the estimated set of image processing operations to generate a third input image representing a version of the second input image for which the estimated set of image processing operations have been compensated; and
cause to be displayed at the display device a second output image using as input the third input image representing the version of the second input image for which the estimated set of image processing operations have been compensated.

32. The system of claim 31, wherein the third input image is an intermediate image, the system comprising circuitry configured to:
apply an image enhancement, a display setting, and an ambient factor relative to the third input image after applying to the second input image the inverse of the estimated set of image processing operations to generate the third input image.

33. The system of claim 31, wherein the estimated set of image processing operations comprises adjustments in color, brightness, contrast, and saturation.

34. The system of claim 31, comprising circuitry configured to iteratively adjust the estimating the set of image processing operations, and the generating the third input image.

35. The system of claim 31, wherein the estimated set of image processing operations comprises capturing an image with an image capture device operating in a RAW image format mode.

36. A system comprising circuitry configured to:
estimate a set of image processing operations for a display device based at least in part on an analysis of (i) a first input image and (ii) a capture of an output image presented by the display device using the first input image as input, wherein the estimated set of image processing operations defines a processing effect of the display device such that applying the estimated set of image processing operations to the first input image generates an approximation of the capture of the output image;
apply to a second input image an inverse of the estimated set of image processing operations to generate a third input image representing a version of the second input image for which the estimated set of image processing operations have been compensated; and
cause to be displayed at the display device a second output image using as input the third input image representing the version of the second input image for which the estimated set of image processing operations have been compensated.

37. The system of claim 36, wherein the circuitry configured to apply the inverse of the estimated set of image processing operations to generate the third input image representing the version of the second input image for which the estimated set of image processing operations have been compensated comprises estimation of processing parameters.

38. The system of claim 37, wherein the circuitry configured to estimate the set of image processing operations is configured to:
estimate application of image processing by the display device to the second input image; and
adjust at least one of brightness, contrast, color, saturation, sharpness, or noise reduction.

39. The system of claim 37, wherein the circuitry configured to apply the inverse of the estimated set of image processing operations to generate the third input image representing the version of the second input image for which the estimated set of image processing operations have been compensated comprises reversing effects of the processing effect of the estimated set of image processing operations.

40. The system of claim 36, wherein the circuitry configured to apply the inverse of the estimated set of image processing operations to generate the third input image representing the version of the second input image for which the estimated set of image processing operations have been compensated comprises generation of a compensated image.

41.-150. (canceled)
